(19) United States
(12) Patent Application Publication
(10) Pub. No.: US 2013/0205218 A1
(43) Pub. Date: Aug. 8, 2013

(54) EVENT TRIGGERED VIEWING

(71) Applicants: Kelly Abuelsaad, Poughkeepsie, NY (US); Kulvir S. Bhogal, Pflugerville, TX (US); Lisa Seacat DeLuca, San Francisco, CA (US); Soobaek Jang, Hamden, CT (US)

(72) Inventors: Kelly Abuelsaad, Poughkeepsie, NY (US); Kulvir S. Bhogal, Pflugerville, TX (US); Lisa Seacat DeLuca, San Francisco, CA (US); Soobaek Jang, Hamden, CT (US)

(73) Assignee: INTERNATIONAL BUSINESS MACHINES CORPORATION, Armonk, NY (US)

(21) Appl. No.: 13/368,680

(22) Filed: Feb. 8, 2012

(51) Int. Cl. G06F 3/048

(52) U.S. Cl. 715/740; 715/733

(57) ABSTRACT

In a method for viewing an event, a computer registers agents such that each agent is communicatively coupled to each other agent. Each agent is associated with a graphical user interface (GUI) session. The computer monitors a first graphical user interface (GUI) session that includes contents viewable on a display device coupled to the computer. The first agent receives, from a second agent, monitoring data associated with a second GUI session. The second GUI session includes contents hidden from view on the display device. The first agent detects an event associated with the second GUI session. In response, the computer displays, on the display device, the event within the contents of the first GUI session.

### FIELD

The present invention relates to a method and associated system for viewing an event.

### BACKGROUND

Managing multiple platforms typically comprises an inaccurate process with little flexibility. Presenting multiple platforms within a system may include a complicated process that may be time consuming and require a large amount of resources.

### SUMMARY

At least one embodiment of the present invention provides a method for viewing an event. The method includes a computer registering a plurality of agents such that each agent of the plurality of agents is communicatively coupled to each other agent of the plurality of agents. Each agent is associated with a graphical user interface (GUI) session of a plurality of GUI sessions. The method further includes the computer monitoring, in a first agent of the plurality of agents, a first GUI session of the plurality of GUI sessions. The first GUI session comprises contents viewable on a display device coupled to the computer. The method further includes the computer receiving, in the first agent and from a second agent of the plurality of agents, monitoring data associated with a second GUI session of the plurality of GUI sessions. The second GUI session comprises contents hidden from view on the display device. The first GUI session differs from the second GUI session. The method further includes, in response to the receiving the monitoring data, the computer detecting, in the first agent, an event associated with the second GUI session. The method further includes, in response to the detecting, the computer displaying, on the display device, the event within the contents of the first GUI session.

At least one embodiment of the present invention provides a computer system. The computer system includes a central processing unit (CPU), a memory coupled to the CPU, and a computer-readable, tangible storage device coupled to the CPU. The storage device contains instructions that, when carried out by the CPU via the memory, implement a method for viewing an event. The method includes the computer system registering a plurality of agents such that each agent of the plurality of agents is communicatively coupled to each other agent of the plurality of agents. Each agent is associated with a graphical user interface (GUI) session of a plurality of GUI sessions. The method further includes the computer system monitoring, in a first agent of the plurality of agents, a first GUI session of the plurality of GUI sessions. The first GUI session comprises contents viewable on a display device coupled to the computer system. The method further includes the computer system receiving, in the first agent and from a second agent of the plurality of agents, monitoring data associated with a second GUI session of the plurality of GUI sessions. The second GUI session comprises contents hidden from view on the display device. The first GUI session differs from the second GUI session. The method further includes, in response to the receiving the monitoring data, the computer system detecting, in the first agent, an event associated with the second GUI session. The method further includes, in response to the detecting, the computer system displaying, on the display device, the event within the contents of the first GUI session.

At least one embodiment of the present invention provides computer program product. The computer program product includes a computer-readable, tangible storage device having computer-readable program instructions stored therein. The computer-readable program instructions, when carried out by a central processing unit (CPU) of a computer system, implement a method for viewing an event. The method includes the computer system registering a plurality of agents such that each agent of the plurality of agents is communicatively coupled to each other agent of the plurality of agents. Each agent is associated with a graphical user interface (GUI) session of a plurality of GUI sessions. The method further includes the computer system monitoring, in a first agent of the plurality of agents, a first GUI session of the plurality of GUI sessions. The first GUI session comprises contents viewable on a display device coupled to the computer system. The method further includes the computer system receiving, in the first agent and from a second agent of the plurality of agents, monitoring data associated with a second GUI session of the plurality of GUI sessions. The second GUI session comprises contents hidden from view on the display device. The first GUI session differs from the second GUI session. The method further includes, in response to the receiving the monitoring data, the computer system detecting, in the first agent, an event associated with the second GUI session. The method further includes, in response to the detecting, the computer system displaying, on the display device, the event within the contents of the first GUI session.

At least one embodiment of the present invention provides a process for supporting computing infrastructure. The process includes providing at least one support service for at least one of creating, integrating, hosting, maintaining, and deploying computer-readable code in a computer system comprising a processor. Instructions contained in the code, when executed by the processor, perform a method for viewing an event. The method includes the computer system registering a plurality of agents such that each agent of the plurality of agents is communicatively coupled to each other agent of the plurality of agents. Each agent is associated with a graphical user interface (GUI) session of a plurality of GUI sessions. The method further includes the computer system monitoring, in a first agent of the plurality of agents, a first GUI session of the plurality of GUI sessions. The first GUI session comprises contents viewable on a display device coupled to the computer. The method further includes the computer system receiving, in the first agent and from a second agent of the plurality of agents, monitoring data associated with a second GUI session of the plurality of GUI sessions. The second GUI session comprises contents hidden from view on the display device. The first GUI session differs from the second GUI session. The method further includes, in response to the receiving the monitoring data, the computer system detecting, in the first agent, an event associated with the second GUI session. The method further includes, in response to the detecting, the computer system displaying, on the display device, the event within the contents of the first GUI session.

The present invention advantageously provides a method and associated system capable of managing multiple platforms.

### BRIEF DESCRIPTION OF THE SEVERAL VIEWS OF THE DRAWINGS

FIG. 1 illustrates a system for automatically viewing events associated with various graphical user interface (GUI) sessions, in accordance with embodiments of the present invention.

FIG. 2 illustrates an algorithm detailing a process flow for automatically viewing events associated with various GUI sessions, in accordance with embodiments of the present invention.

FIGS. 3A and 3B illustrate screen shot examples for implementing a process for automatically viewing events associated with various GUI sessions, in accordance with embodiments of the present invention.

FIG. 4 illustrates a computer apparatus used for automatically viewing events associated with various GUI sessions, in accordance with embodiments of the present invention.

### DETAILED DESCRIPTION

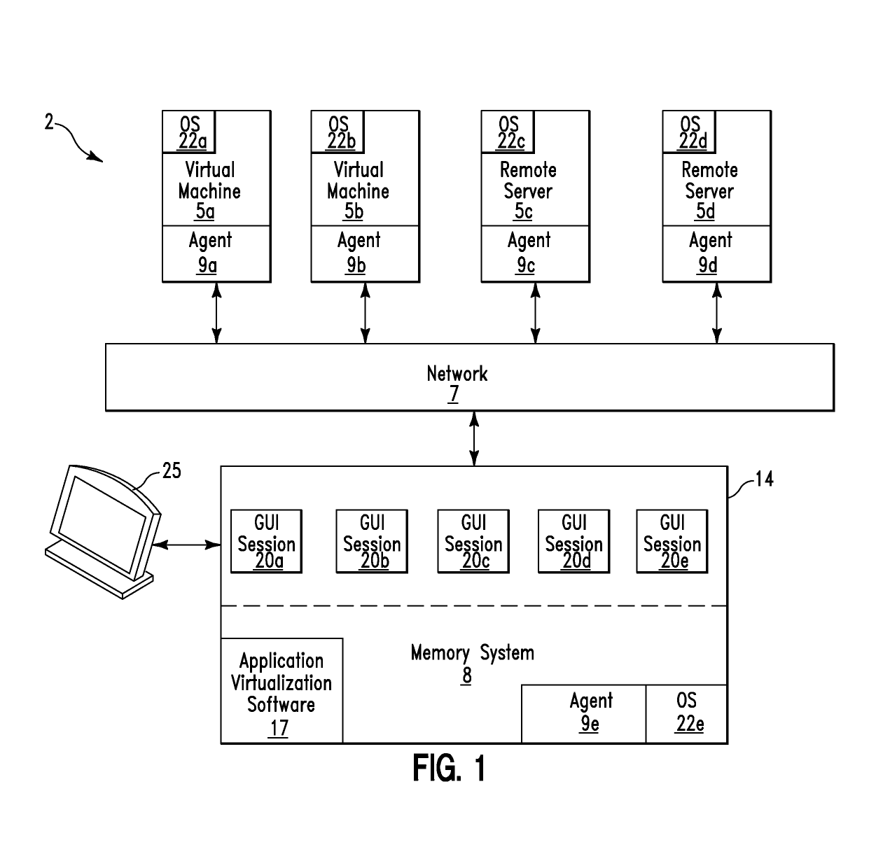

FIG. 1 illustrates a system 2 for automatically viewing events associated with various graphical user interface (GUI) sessions 20a . . . 20e, in accordance with embodiments of the present invention. A GUI session (e.g., GUI sessions 20a . . . 20e) is defined herein as an operating system session associated with an operating system being executed by a local computer and/or a remote computer.

System 2 of FIG. 1 comprises virtual machines 5a and 5b and remote servers 5c and 5d connected through a network 7 to a (local) computing system 14. Additionally, a display device 25 (e.g., a monitor such as, inter alia, a CRT monitor, an LCD monitor, an LED monitor, etc) is connected to computing system 14. Network 7 may comprise any type of network including, inter alia, a local area network, (LAN), a wide area network (WAN), the Internet, a wireless network, etc. Computing system 14 may comprise any type of computing system(s) including, inter alia, a computer (PC), a laptop computer, a tablet computer, a server, a PDA, a smart phone, etc. Computing system 14 comprises a memory system 8. Memory system 8 may comprise a single memory system. Alternatively, memory system 8 may comprise a plurality of memory systems. Memory system 8 comprises application virtualization software 17, an operating system (OS) 22e, and an agent 9e. Virtual machine 5a comprises an OS 22a (enabling a GUI session 20a running on computing system 14) and an agent 9a for monitoring GUI session 20a. Virtual machine 5b comprises an OS 22b (enabling a GUI session 20b running on computing system 14) and an agent 9b for monitoring GUI session 20b. Remote server 5c comprises an OS 22c (enabling a GUI session 20c running on computing system 14) and an agent 9c for monitoring GUI session 20c. Remote server 5d comprises an OS 22d (enabling a GUI session 20d running on computing system 14) and an agent 9d for monitoring GUI session 20d. Computing system 14 comprises OS 22e (enabling GUI session 20e running on computing system 14) and agent 9e for monitoring GUI session 20e. Computing system 14 may additionally comprise multiple operating systems and associated agents.

Computing system 14 enables GUI sessions 20a . . . 20e executed by OS 22a . . . 22e, respectively. Computing system 14 allows users to launch/operate virtual machines 5a and 5b and/or remote servers 5c and 5d on computing system 14. The virtual machines 5a and 5b and/or remote servers 5c and 5d enable GUI sessions 20a . . . 20d (and associated applications) to operate on computing system 14.

System 2 enables a process for dynamically/automatically viewing (via display device 25) software applications and/or notifications/events associated with remote GUI sessions (e.g., GUI sessions 20a . . . 20d) and local GUI sessions (e.g., GUI session 20e) via a GUI session being currently viewed (i.e., in focus) by a user. Application virtualization software 17 allows a user to configure types of applications/events that will trigger a remote session (e.g., one of GUI sessions 20a . . . 20d) of an application/event (i.e., currently running but not being viewed) to appear on a GUI session in a current view. For example, if the user is running three remote desktop sessions (e.g., GUI sessions 20a . . . 20c) on computing system 14, a triggered application/event (from any of the three remote desktop sessions) may be monitored (by an associated one of agents 9a . . . 9e) and presented to the user via the remote desktop session currently active or in current view (e.g., currently in focus or maximized). If the user enables another remote desktop session (currently active or in current view), all future applications/events from any of the GUI sessions 20a . . . 20e will be automatically presented to the user via a remote desktop session currently active or in current view. Additionally, application pop-ups (e.g., an instant messenger application) being executed by a desktop session (not currently in view) may be configured to be automatically presented to a user via a currently active (or in current view) desktop session.

The following implementation example describes a usage process enabled by system 2 for presenting an instant messaging chat window from a locally running instant messaging application on any of GUI sessions 20a . . . 20e currently viewable on the display device 25:

1. A user launches an instant messaging application on GUI session 20e (e.g., on a local machine).
2. The user configures GUI session 20e to recognize any new windows or notifications associated with the locally running instant messaging application.
3. The user launches GUI session 20c (a new remote session) from virtual machine 5c on computing system 14.
4. The user launches GUI session 20a (a new virtual machine session) from virtual machine 5a on computing system 14.
5. The user begins viewing GUI session 20a on the display device 25.
6. A new chat notification (for the instant messaging application) is received by GUI session 20e and automatically displayed (in response to a command from agent 9a) within contents of GUI session 20a (i.e., the GUI session being currently viewed).
7. The user responds to the chat notification.
8. The user switches from GUI session 20a to GUI session 20c thereby viewing GUI session 20c on the display device 25.
9. The user receives another new chat notification on GUI session 20e and the new chat notification is automatically displayed (in response to a command from agent 9c) within contents of GUI session 20c (i.e., the GUI session being currently viewed).
10. The user responds to the new chat notification.

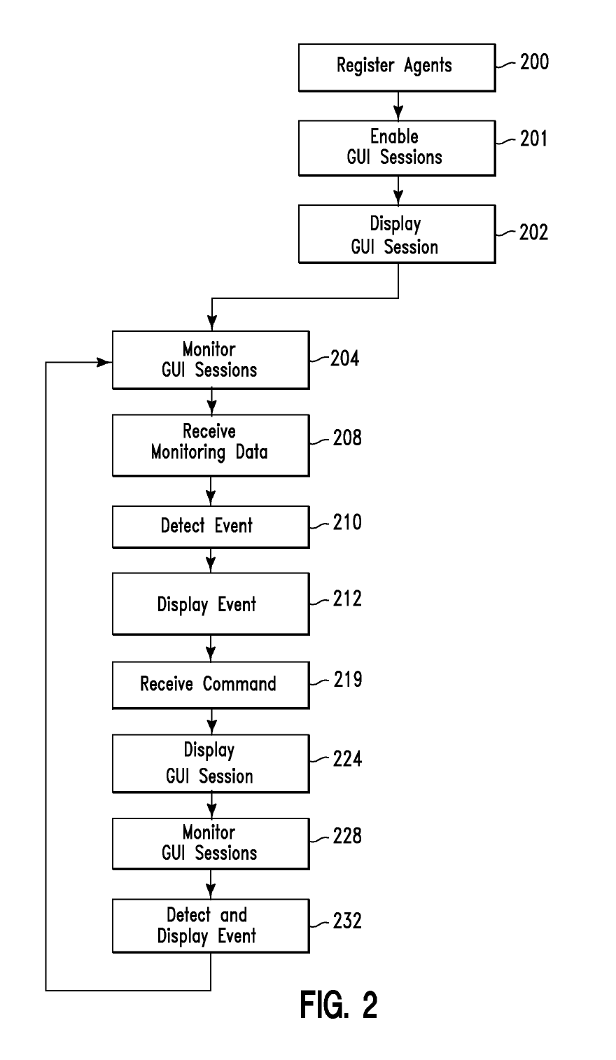

FIG. 2 illustrates an algorithm detailing a process flow enabled by system 2 of FIG. 1 for automatically viewing events associated with various GUI sessions, in accordance with embodiments of the present invention. In step 200, a plurality of agents (e.g., agents 9a . . . 9e of FIG. 1) associated with a plurality of graphical user interface (GUI) sessions (e.g., GUI 20a . . . 20e sessions of FIG. 1) are registered with each other such that each agent is communicatively coupled to each other agent. Therefore each of the agents may transmit monitoring data to each other resulting in the detection of events occurring in any of the GUI sessions. In step 201, multiple GUI sessions are enabled (e.g., launched) on a computing system (e.g., computing system 14 of FIG. 1). In step 202, a first GUI session of the multiple GUI sessions is displayed (in response to a user command) on a monitor (e.g., display device 25 of FIG. 1). In step 204, agents monitor associated GUI sessions (e.g., GUI 20a . . . 20e sessions of FIG. 1, respectively) for associated events (e.g., instant messaging notifications). In step 208, a first agent (i.e., associated with the first GUI session) receives (from all additional agents associated with the additional GUI sessions comprising contents hidden from view on the display device) monitoring data associated with the additional GUI sessions. The monitoring data specifies any events occurring in any of the GUI sessions that are minimized or currently not in view on the monitor. In step 210, the first agent detects (based on monitoring data from a second agent) an event associated with a second GUI session (comprising contents hidden from view on the display device). In step 212, the event is displayed (on the display device) within the contents of the first GUI session. In step 219, the computing system receives a user command for displaying the second GUI session of the multiple GUI sessions on the display device such that the contents of the first GUI session are hidden from view on the display device. In step 224, the computer displays the second GUI session on the display device. In step 228, the agents monitor the associated GUI sessions for associated events (e.g., instant messaging notifications). In step 232, an additional event associated with an additional GUI session is detected and displayed within the contents of the second GUI session and step 204 is repeated to monitor the GUI sessions for events.

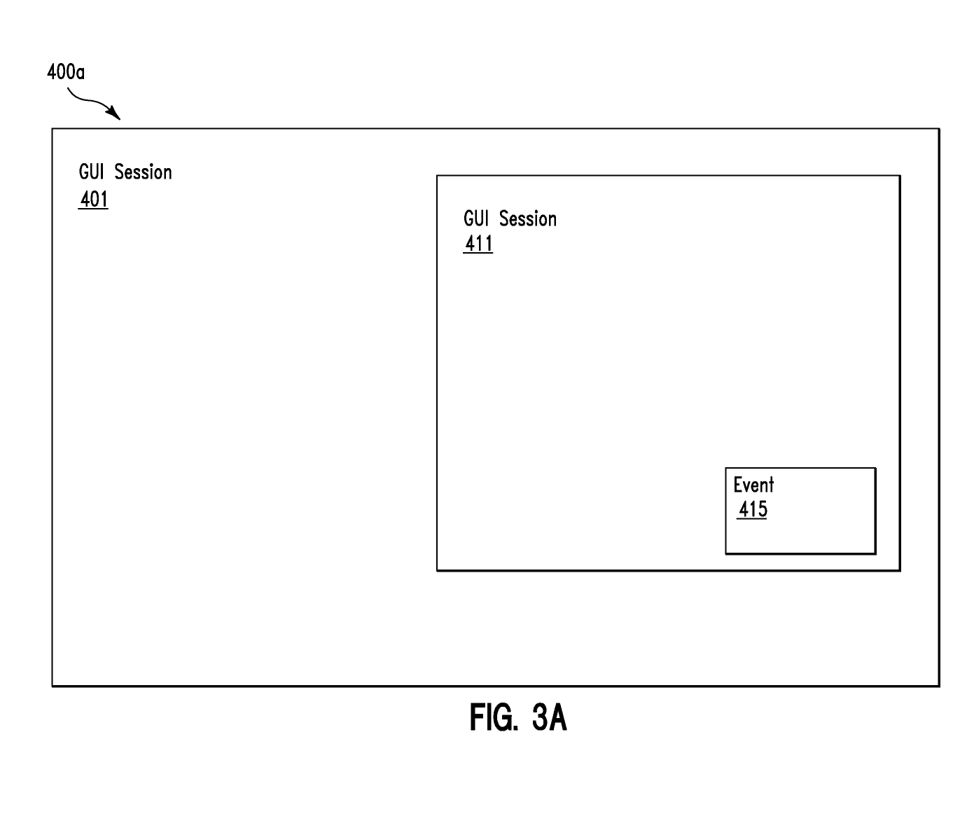

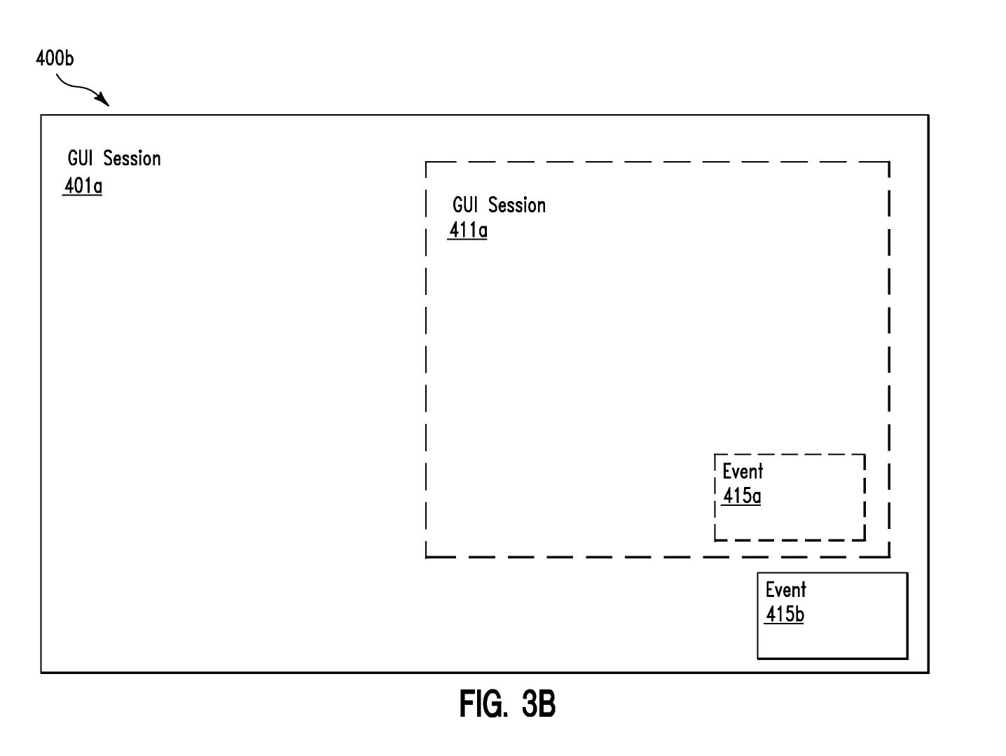

FIG. 3A illustrates a screen shot 400a for implementing a process for automatically viewing events associated with various GUI sessions, in accordance with embodiments of the present invention. Screen shot 400a comprises a viewable (i.e., in focus) GUI session 411 comprising an enabled event 415. GUI session 401 is not viewable and therefore GUI session 401 is unable to detect or present an enabled event 415.

FIG. 3B illustrates a screen shot 400b for implementing a process for automatically viewing events associated with various GUI sessions, in accordance with embodiments of the present invention. Screen shot 400b comprises a non-viewable (i.e., not in focus) GUI session 411a comprising an enabled event 415a. GUI session 401a is viewable (i.e., in focus) and therefore GUI session 401a presents the event 415a on GUI session 401 as an event 415b.

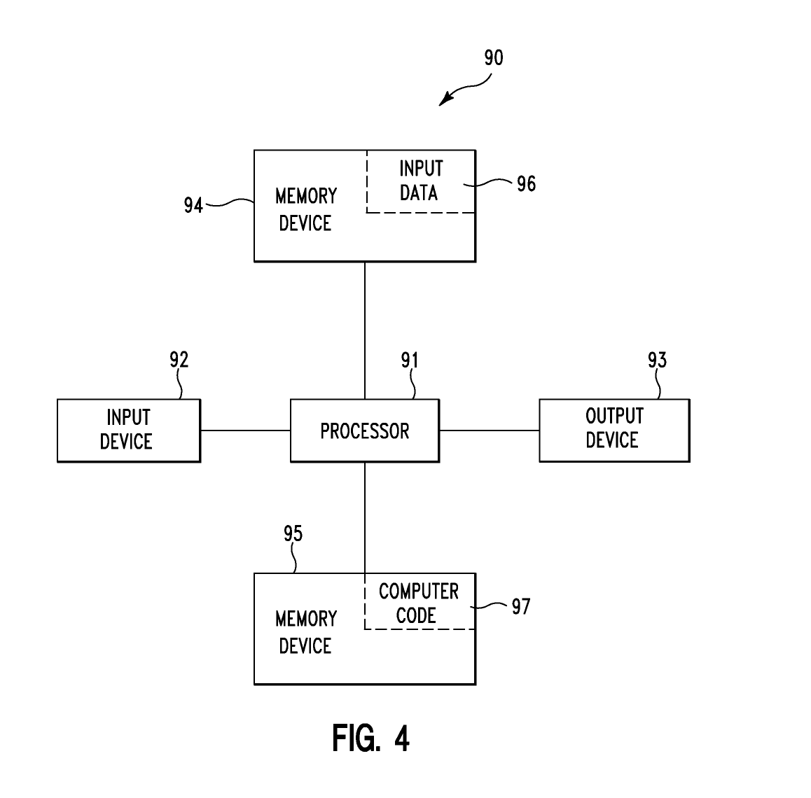

FIG. 4 illustrates a computer apparatus 90 used by system 2 of FIG. 1 for automatically viewing events associated with various GUI sessions, in accordance with embodiments of the present invention. The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes agent code for a plurality of agents (e.g., agents 9a . . . 9e of FIG. 1) enabled for automatically viewing events associated with various GUI sessions. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may comprise computer code and may be used as a computer usable medium (or a computer readable medium or a program storage device) having a computer readable program code embodied therein and/or having other data stored therein, wherein the computer readable program code comprises the computer code 97. Generally, a computer program product (or, alternatively, an article of manufacture) of the computer system 90 may comprise the computer usable medium (or said program storage device).

Still yet, any of the components of the present invention could be created, integrated, hosted, maintained, deployed, managed, serviced, etc. by a service supplier who offers to automatically view events associated with various GUI sessions. Thus the present invention discloses a process for deploying, creating, integrating, hosting, maintaining, and/or integrating computing infrastructure, comprising integrating computer-readable code into the computer system 90, wherein the code in combination with the computer system 90 is capable of performing a method for automatically viewing events associated with various GUI sessions. In another embodiment, the invention provides a business method that performs the process steps of the invention on a subscription, advertising, and/or fee basis. That is, a service supplier, such as a Solution Integrator, could offer to automatically view events associated with various GUI sessions. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for viewing an event, the method comprising the steps of:
a computer registering a plurality of agents such that each agent of said plurality of agents is communicatively coupled to each other agent of said plurality of agents, wherein each said agent is associated with a graphical user interface (GUI) session of a plurality of GUI sessions;
the computer monitoring, in a first agent of said plurality of agents, a first GUI session of said plurality of GUI sessions, wherein said first GUI session comprises contents viewable on a display device coupled to the computer;
the computer receiving, in the first agent and from a second agent of said plurality of agents, monitoring data associated with a second GUI session of said plurality of GUI sessions, wherein the second GUI session comprises contents hidden from view on the display device, and wherein the first GUI session differs from the second GUI session;
in response to the receiving the monitoring data, the computer detecting, in the first agent, an event associated with the second GUI session; and
in response to the detecting, the computer displaying, on the display device, the event within the contents of the first GUI session.

2. The method of claim 1, further comprising the steps of:
in response to a user command, the computer displaying, on the display device, the second GUI session such that the contents of the second GUI session are viewable on the display device and the contents of the first GUI session are hidden from view on the display device;
the computer additionally monitoring, in the first agent, the first GUI session comprising the contents of the first GUI session that are hidden from view on the display device;
in response to the additionally monitoring, the computer detecting, in the first agent, an additional event associated with the first GUI session; and
in response to the detecting the additional event, the computer displaying, on the display device, the additional event within the contents of the second GUI session.

3. The method of claim 1, wherein the first GUI session and the second GUI session are comprised by the computer.

4. The method of claim 1, wherein the first GUI session is comprised by the computer, and wherein the second GUI session is a remote session comprised by a remote server communicatively coupled to the computer.

5. The method of claim 1, wherein the first GUI session is a first remote session comprised by a first remote server communicatively coupled to the computer, wherein the second GUI session is a second remote session comprised by a second remote server communicatively coupled to the computer, and wherein the first remote server differs from the second remote server.

6. The method of claim 1, wherein the first GUI session is comprised by one of: a local operating system, a virtual machine, and a remote server, and wherein the second GUI session is comprised by one of a local operating system, a virtual machine, and a remote server.

7. The method of claim 1, further comprising the step of:
the computer maximizing a graphical window for viewing the contents of the first GUI session.

8. The method of claim 1, further comprising the steps of:
before the step of the computer receiving the monitoring data, the computer receiving user input identifying the second GUI session; and
the computer storing the user input and a configuration for displaying events received by the computer.

9. A computer system comprising:
a central processing unit (CPU);
a memory coupled to the CPU;
a computer-readable, tangible storage device coupled to the CPU, the storage device containing instructions that, when carried out by the CPU via the memory, implement a method for viewing an event, the method comprising the steps of:
the computer system registering a plurality of agents such that each agent of said plurality of agents is communicatively coupled to each other agent of said plurality of agents, wherein each said agent is associated with a graphical user interface (GUI) session of a plurality of GUI sessions;
the computer system monitoring, in a first agent of said plurality of agents, a first GUI session of said plurality of GUI sessions, wherein said first GUI session comprises contents viewable on a display device coupled to the computer system;
the computer system receiving, in the first agent and from a second agent of said plurality of agents, monitoring data associated with a second GUI session of said plurality of GUI sessions, wherein the second GUI session comprises contents hidden from view on the display device, and wherein the first GUI session differs from the second GUI session;
in response to the receiving the monitoring data, the computer system detecting, in the first agent, an event associated with the second GUI session; and
in response to the detecting, the computer system displaying, on the display device, the event within the contents of the first GUI session.

10. The computer system of claim 9, wherein the method further comprises the steps of:
in response to a user command, the computer system displaying, on the display device, the second GUI session such that the contents of the second GUI session are viewable on the display device and the contents of the first GUI session are hidden from view on the display device;
the computer system additionally monitoring, in the first agent, the first GUI session comprising the contents of the first GUI session that are hidden from view on the display device;
in response to the additionally monitoring, the computer system detecting, in the first agent, an additional event associated with the first GUI session; and
in response to the detecting the additional event, the computer system displaying, on the display device, the additional event within the contents of the second GUI session.

11. The computer system of claim 9, wherein the first GUI session and the second GUI session are comprised by the computer system.

12. The computer system of claim 9, wherein the first GUI session is comprised by the computer system, and wherein the second GUI session is a remote session comprised by a remote server communicatively coupled to the computer system.

13. The computer system of claim 9, wherein the first GUI session is a first remote session comprised by a first remote server communicatively coupled to the computer system, wherein the second GUI session is a second remote session comprised by a second remote server communicatively coupled to the computer system, and wherein the first remote server differs from the second remote server.

14. The computer system of claim 9, wherein the first GUI session is comprised by one of: a local operating system, a virtual machine, and a remote server, and wherein the second GUI session is comprised by one of a local operating system, a virtual machine, and a remote server.

15. The computer system of claim 9, wherein the method further comprises the step of:
the computer system maximizing a graphical window for viewing the contents of the first GUI session.

16. The computer system of claim 9, wherein the method further comprises the steps of:
before the step of the computer system receiving the monitoring data, the computer system receiving user input identifying the second GUI session; and
the computer system storing the user input and a configuration for displaying events received by the computer system.

17. A computer program product comprising a computer-readable, tangible storage device having computer-readable program instructions stored therein, the computer-readable program instructions, when carried out by a central processing unit (CPU) of a computer system, implement a method for viewing an event, the method comprising the steps of:
the computer system registering a plurality of agents such that each agent of said plurality of agents is communicatively coupled to each other agent of said plurality of agents, wherein each said agent is associated with a graphical user interface (GUI) session of a plurality of GUI sessions;
the computer system monitoring, in a first agent of said plurality of agents, a first GUI session of said plurality of GUI sessions, wherein said first GUI session comprises contents viewable on a display device coupled to the computer system;
the computer system receiving, in the first agent and from a second agent of said plurality of agents, monitoring data associated with a second GUI session of said plurality of GUI sessions, wherein the second GUI session comprises contents hidden from view on the display device, wherein the first GUI session differs from the second GUI session;
in response to the receiving the monitoring data, the computer system detecting, in the first agent, an event associated with the second GUI session; and
in response to the detecting, the computer system displaying on the display device, the event within the contents of the first GUI session.

18. The computer program product of claim 17, wherein the first GUI session and the second GUI session are comprised by the computer system.

19. The computer program product of claim 17, wherein the first GUI session is comprised by the computer system, and wherein the second GUI session is a remote session comprised by a remote server communicatively coupled to the computer system.

20. A process for supporting computing infrastructure, the process comprising providing at least one support service for at least one of creating, integrating, hosting, maintaining, and deploying computer-readable code in a computer system comprising a processor, wherein instructions contained in the code, when executed by the processor, perform a method for viewing an event, wherein the method comprises the steps of:
the computer system registering a plurality of agents such that each agent of said plurality of agents is communicatively coupled to each other agent of said plurality of agents, wherein each said agent is associated with a graphical user interface (GUI) session of a plurality of GUI sessions;
the computer system monitoring, in a first agent of said plurality of agents, a first GUI session of said plurality of GUI sessions, wherein said first GUI session comprises contents viewable on a display device coupled to the computer system;
the computer system receiving, in the first agent and from a second agent of said plurality of agents, monitoring data associated with a second GUI session of said plurality of GUI sessions, wherein the second GUI session comprises contents hidden from view on the display device, wherein the first GUI session differs from the second GUI session;
in response to the receiving the monitoring data, the computer system detecting, in the first agent, an event associated with the second GUI session; and
in response to the detecting, the computer system displaying, on the display device, the event within the contents of the first GUI session.
